(19) United States
(12) Patent Application Publication
(10) Pub. No.: US 2026/0163188 A1
(43) Pub. Date: Jun. 11, 2026

(54) BATTERY AND ELECTRONIC DEVICE

(71) Applicant: Zhuhai CosMX Battery Co., Ltd., Zhuhai (CN)

(72) Inventors: Shichang Zhou, Zhuhai (CN); Zhida Wei, Zhuhai (CN); Jichun Xie, Zhuhai (CN); Xilong Li, Zhuhai (CN)

(21) Appl. No.: 19/180,366

(22) Filed: Apr. 16, 2025

Related U.S. Application Data
(63) Continuation of application No. PCT/CN2023/116275, filed on Aug. 31, 2023.

(30) Foreign Application Priority Data
Nov. 14, 2022 (CN) 202223024516.9

(51) Int. Cl. H01M 50/477; H01M 50/103; H01M 50/474

(52) U.S. Cl. CPC H01M 50/477; H01M 50/103; H01M 50/474

(57) ABSTRACT

This application provides a battery and an electronic device. The battery includes a shell, a cell, a connecting member and an insulating layer, where the shell has a cavity, both the cell and the connecting member are located in the cavity, an end of the cell is provided with a first tab and a second tab, and a part of the connecting member is connected with the first tab. The insulating layer is located between the first tab and the second tab, and a projection of the insulating layer on an end surface of the cell covers at least a part of a projection of the connecting member on the end surface of the cell. The arrangement of the insulating layer can avoid a short circuit of the battery due to direct contact between the connecting member and the cell to ensure the normal use of the battery.

### CROSS-REFERENCE TO RELATED APPLICATIONS

This application is a continuation of International Application No. PCT/CN 2023/116275, filed on Aug. 31, 2023, which claims priority to Chinese patent application No. 202223024516.9, entitled “Battery and Electronic Device”, and filed with the China National Intellectual Property Administration on Nov. 14, 2022. Both of the aforementioned applications are hereby incorporated by reference in their entireties.

### TECHNICAL FIELD

This application relates to the field of batteries and, in particular, to a battery and an electronic device.

### BACKGROUND

With the development of science and technology, electrochemical devices represented by the batteries have been widely used. For example, lithium-ion batteries have the advantages of large capacity, small size, light weight, green and environmental friendliness and the like, and have been widely used in industries such as digital electronic products and electric vehicles.

In the related art, the connection between a positive tab or a negative tab and a post is achieved by a connecting sheet. Generally, the connecting sheet is Z-shaped, with one end of the connecting sheet connected with the tab and the other end thereof connected with the post, to achieve the connection between the tab and the post.

However, the connecting sheet may come into contact with an end of the battery during an installation process or a usage process, which may easily cause a short circuit of the battery.

### SUMMARY

In order to solve at least one of the problems mentioned in the background, this application provides a battery and an electronic device, aiming to solve the technical problem that the connecting sheet may come into contact with the end of the battery during the installation process or the usage process, which may easily cause the short circuit of the battery.

In order to achieve the above object, in a first aspect, this application provides a battery, including a shell, a cell, a connecting member and an insulating layer, where the shell has a cavity, both the cell and the connecting member are located in the cavity, an end of the cell is provided with a first tab and a second tab, and a part of the connecting member is connected with the first tab;
the insulating layer is located between the first tab and the second tab, and a projection of the insulating layer on an end surface of the cell covers at least a part of a projection of the connecting member on the end surface of the cell.

In the above battery, in a possible implementation, the insulating layer covers at least the connecting member and a side of the first tab away from the cell.

In the above battery, in a possible implementation, the connecting member includes: a first section and a second section, extension directions of which are parallel to each other, and a connecting section connecting the first section and the second section, and an extension direction of the connecting section intersects with an extension direction of the first section;
the first section is connected with the first tab.

In the above battery, in a possible implementation, the insulating layer includes an intermediate insulating portion, and the intermediate insulating portion covers at least projections of the second section and a part of the connecting section on the cell;
and/or, the insulating layer includes a tab insulating portion, and the tab insulating portion covers at least the first section and a part of the connecting section.

In the above battery, in a possible implementation, the intermediate insulating portion includes a first area and a second area, the first area corresponds to a projection of the second section on the cell, and the second area corresponds to a projection of the connecting section on the cell; the tab insulating portion includes a third area and a fourth area, the third area corresponds to a projection of the connecting section on the tab, and the fourth area corresponds to the first section;

a ratio of a length of the second area to a length of the projection of the connecting section on the cell is 0%-50%; a ratio of a length of the third area to the length of the projection of the connecting section on the cell is 0%-50%.

In the above battery, in a possible implementation, an angle between the connecting section and the first section or the second section of the connecting member is A, and a distance between the first section and the second section in a direction in which the connecting member approaches or moves away from the cell is B,
a sum of the length of the second area and the length of the third area is less than B/tan A.

In the above battery, in a possible implementation, an amount of the connecting member is 2, the two connecting members are respectively connected to the first tab and the second tab, an area between the first tab and the second tab is a middle area, and both the two connecting members are located in the middle area;
the projection of the insulating layer on the end surface of the cell covers at least a part of projections of the two connecting members on the end surface of the cell.

In the above battery, in a possible implementation, the intermediate insulating portion is located between the end of the cell and the connecting member, and the tab insulating portion covers at least a connection area of the connecting member with the first tab.

In the above battery, in a possible implementation, the insulating layer is insulating glue.

In a second aspect, this application further provides an electronic device, including a device shell and the battery, where the battery is located inside the device shell.

In the battery and the electronic device provided by this application, all of the cell, the connecting member and the insulating layer are located in the shell. The shell can provide protection to prevent the battery from being affected by collision. The first tab and the second tab are provided at the end of the cell, and electric connection for the cell is achieved through the first tab and the second tab. A part of the connecting member is connected to the tab for the electric connection to the tab. The insulating layer is located between the first tab and the second tab, and the projection of the insulating layer on the end surface of the cell covers at least the part of the projection of the connecting member on the end surface of the cell, which can avoid a short circuit of the battery due to direct contact between the connecting member and the cell, thereby ensuring the normal use of the battery.

The configuration of this application, and other application objects and beneficial effects thereof will be more clearly understood through the description of the preferred embodiments in conjunction with the accompanying drawings.

### BRIEF DESCRIPTION OF DRAWINGS

In order to more clearly illustrate embodiments of this application or the technical solutions in the prior art, the accompanying drawings required in the description of the embodiments or the prior art will be briefly introduced hereinafter. Obviously, the accompanying drawings described below are some embodiments of this application. For those of ordinary skill in the art, other accompanying drawings can be obtained based on these accompanying drawings without making any creative work.

FIG. 1 is a schematic diagram showing a structure of a battery provided in an embodiment of this application.

FIG. 2 is a schematic diagram showing a structure of a battery in a direction provided in an embodiment of this application.

FIG. 3 is a schematic diagram of an enlarged structure at D in FIG. 2.

FIG. 4 is a schematic diagram of a structure of an electronic device provided in an embodiment of this application.

### DESCRIPTION OF REFERENCE SIGNS

100—Battery;
110—Shell;
120—Cell;
121—First tab;
122—Second tab;
130—Connecting member;
140—Insulating layer;
111—Cavity;
150—Cover plate;
131—First section;
132—Second section;
133—Connecting section;
141—Intermediate insulating portion;
1411—First area;
1412—Second area;
142—Tab insulating portion;
1421—Third area;
1422—Fourth area;
200—Electronic device;
210—Device shell.

The above accompanying drawings have shown specific embodiments of this application, which will be described in more detail hereinafter. These accompanying drawings and textual descriptions are not intended to limit the scope of this application in any way, but rather to illustrate the concept of this application to those skilled in the art by referring to specific embodiments.

### DESCRIPTION OF EMBODIMENTS

In the related art, a connection between a positive tab or a negative tab and a post is achieved by a Z-shaped connecting sheet in most of steel-shelled lithium batteries. The connecting sheet has one end connected with the tab, and the other end connected with the post. Due to the shape of the Z-shaped connecting sheet, there is a certain height difference between two ends of the connecting sheet. Correspondingly, the end connected with the post is closer to an end of a cell. During installation or collision, the connecting sheet may come into contact with the end of the cell, which may easily cause a short circuit and fail to ensure the normal use of the battery.

Based on the above technical problem, embodiments of this application provide a battery and an electronic device. The battery includes a shell, a cell, a connecting member and an insulating layer, the shell has a cavity, both the cell and the connecting member are located in the cavity, an end of the cell is provided with a first tab and a second tab, and a part of the connecting member is connected with the first tab. The insulating layer is located between the first tab and the second tab, and a projection of the insulating layer on an end surface of the cell covers at least a part of a projection of the connecting member on the end surface of the cell. All of the cell, the connecting member and the insulating layer are located in the shell, which can provide protection to prevent the battery from being affected by collision. The end of the cell is provided with the first tab and the second tab, and electric connection for the cell is achieved through the first tab and the second tab. A part of the connecting member is connected to the tab for the electric connection to the tab. The insulating layer is located between the first tab and the second tab, and the projection of the insulating layer on the end surface of the cell covers at least the part of the projection of the connecting member on the end surface of the cell, which can avoid a short circuit of the battery due to direct contact between the connecting member and the cell, thereby ensuring the normal use of the battery.

In order to make the purpose, technical solutions and advantages of this application clearer, the technical solutions in the embodiments of this application will be described in more detail below in conjunction with the accompanying drawings in the preferred embodiments of this application. The same or similar reference signs throughout the accompanying drawings represent the same or similar components or components having the same or similar functions. The embodiments described are only part of the embodiments of this application, rather than all of the embodiments. The embodiments described below with reference to the accompanying drawings are for example purposes and are intended for explaining this application, but should not be considered as limiting this application. All other embodiments obtained by those of ordinary skill in the art based on the embodiments in this application without making any creative work shall fall within the protection scope of this application. The embodiments of this application are described in detail below in conjunction with the accompanying drawings.

In the description of the embodiments of this application, it should be understood that, unless otherwise clearly specified and defined, the terms “installed”, “connected” and “connection” should be understood in a broad sense. For example, it can be a fixed connection or an indirect connection through an intermediate medium, or can be an internal communication between two elements or an interaction relationship between two elements. For those of ordinary skill in the art, the specific meanings of the above terms in this application can be understood according to specific circumstances.

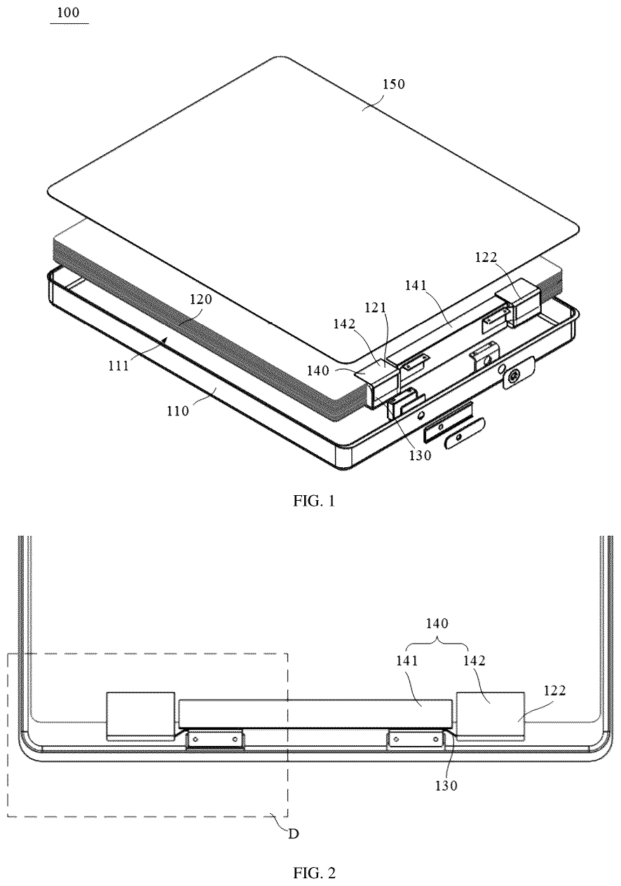

FIG. 1 is a schematic diagram showing a structure of a battery provided in an embodiment of this application.

FIG. 2 is a schematic diagram showing a structure of a battery in a direction provided in an embodiment of this application.

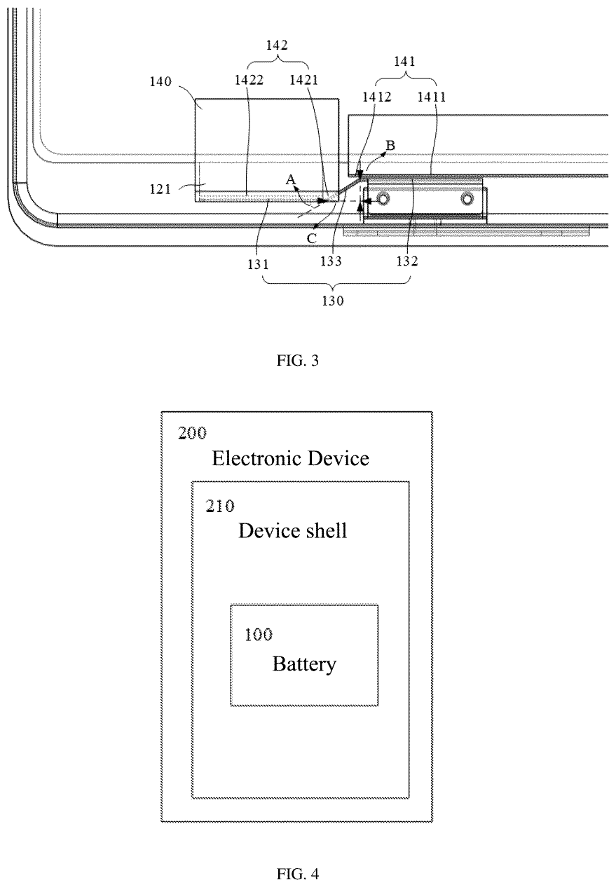

FIG. 3 is a schematic diagram of an enlarged structure at D in FIG. 2.

Referring to FIG. 1, the embodiment of this application provides a battery 100, which includes a shell 110, a cell 120, a connecting member 130, and an insulating layer 140.

Specifically, the shell 110 has a cavity 111, and both the cell 120 and the connecting member 130 are located in the cavity 111. The shell 110 can protect the cell 120 and the connecting member 130. An end of the cell 120 is provided with a first tab 121 and a second tab 122. In order to facilitate electric connection of the cell 120, both the first tab 121 and the second tab 122 are located at the end of the cell 120 close to the periphery, and can be spaced apart from each other. A part of the connecting member 130 is connected with the first tab 121, and the other part corresponds to the cell 120.

Furthermore, the insulating layer 140 can be located between the first tab 121 and the second tab 122. A projection of the insulating layer 140 on an end surface of the cell 120 covers at least a part of a projection of the connecting member 130 on the end surface of the cell 120. A short circuit of the battery 100 due to direct contact between the connecting member 130 and the cell 120 can be avoided, thereby ensuring the normal use of the battery 100.

It can be understood that the first tab 121 and the second tab 122 may be exactly identical, and the following description of the first tab 121 applies also to the second tab 122.

It should be noted that the shell 110 may be made of stainless steel, and the material of the shell 110 is not limited in the embodiments of this application. The shell 110 may include a bottom wall and a side wall. The bottom wall may be circular, elliptical, etc. The side wall of the shell 110 surrounds the outer edge of the bottom wall, and the side wall is connected to the outer edge of the bottom wall, so that the above cavity 111 is enclosed by the side wall and the bottom wall. Meanwhile, a top of the shell 110 may be provided with an opening, and the opening is in communication with the cavity 111.

It can be understood that the battery 100 may further include a cover plate 150, by which the opening at the top of the shell 110 is sealed with the shell 110 to form the cavity 111. The material of the cover plate 150 may be the same as or different from that of the shell 110. The material of the cover plate 150 is not limited in the embodiments of this application.

As a possible implementation, the insulating layer 140 also covers at least the connecting member 130 and a side of the first tab 121 away from the cell 120. That is, after the connecting member 130 is connected with the first tab 121, the side of the tab 121 away from the cell 120 is covered by the insulating layer 140, which can avoid contact between the connecting member 130 electrically connected with the first tab 121 and the shell 110, thereby protecting the connecting member 130 electrically connected with the first tab 121.

It can be understood that the insulating layer 140 may also cover a side of the second tab 122 away from the cell 120. That is, after the connecting member 130 is connected with the second tab 122, the side of the second tab 122 away from the cell 120 is covered by the insulating layer 140, which can avoid contact between the connecting member 130 electrically connected with the second tab 122 and the shell 110, thereby protecting the connecting member 130 electrically connected with the second tab 122.

As a possible embodiment, referring to FIG. 1, FIG. 2 and FIG. 3, the connecting member 130 includes: a first section 131 and a second section 132, the extension directions of which are parallel to each other, and a connecting section 133 connecting the first section 131 and the second section 132; the extension direction of the connecting section 133 intersects with the extension direction of the first section 131, that is, the connecting member 130 has a Z-shaped shape.

Specifically, the first section 131 is connected with the first tab 121, and the first section 131 is fitted and connected to a side surface of the first tab 121 away from the cell 120. The second section 132 corresponds to the end of the cell 120 and is provided on the end of the cell 120. The connecting section 133 serves as a middle section connecting the first section 131 and the second section 132. A part of the connecting section 133 close to the first section 131 is connected with the first tab 121, and the second section 132 and the first tab 121 are spaced apart from each other.

It can be understood that the first section 131, the second section 132 and the connecting section 133 can be an integrally-molded structure, or can be connected by welding, bonding, etc. The molding method of the connecting member 130 is neither limited in this application, nor limited to the above examples.

It should be noted that material of the connecting member 130 can be copper, or aluminum, or other electrically conductive materials. The material of the connecting member 130 is neither limited in the embodiments of this application, nor limited to the above examples.

As a possible embodiment, referring to FIG. 1, FIG. 2 and FIG. 3, the insulating layer 140 includes an intermediate insulating portion 141, and the intermediate insulating portion 141 covers at least projections of the second section 132 and a part of the connecting section 133 on the cell 120.

Specifically, the intermediate insulating portion 141 may cover a orthographic projection of the second section 132 of the connecting member 130 on the end of the cell 120. That is, the intermediate insulating portion 141 is located between the connecting member 130 and the end of the cell 120. During the installation process or the usage process of the battery 100, the connecting member 130 may be shifted and approach the end of the cell 120 and come into contact with the end of the cell 120, causing a short circuit of the battery 100, making it impossible to ensure the normal use of the battery 100.

Furthermore, the intermediate insulating portion 141 may also cover the part of the connecting section 133 of the connecting member 130 close to the second section 132 to increase the coverage of the intermediate insulating portion 141, and increase the coverage of the insulating layer 140, and reduce the possibility of contact between the second section 132 of the connecting member 130 and the end of the cell 120, thereby ensuring the normal use of the battery 100.

As a possible embodiment, referring to FIG. 1, FIG. 2 and FIG. 3, the intermediate insulating portion 141 includes a first area 1411 and a second area 1412. The first area 1411 corresponds to the projection of the second section 132 on the cell 120, and the second area 1412 corresponds to the projection of the connecting section 133 on the cell 120. A ratio of the length of the second area 1412 to the length of the projection of the connecting section 133 on the cell 120 is 0%-50%.

Specifically, the second area 1412 may be a projection of the part of the connecting section 133 close to the first section 131 on the end of the cell 120, and the first area 1411 may be a projection of the second section 132 on the end of the cell 120. The first area 1411 and the second area 1412 may be adjacent to each other.

It should be noted that the ratio of the length of the second area 1412 to the length of the projection of the connecting section 133 on the cell 120 may be greater than 0% and less than or equal to 50%. Preferably, the ratio of the length of the second area 1412 to the length of the projection of the connecting section 133 on the cell 120 may be greater than or equal to 20% and less than or equal to 50%. For example, the length ratio may be 20%, 25%, 30%, 35%, 40%, 45% or 50%. The specific ratio of the length of the second area 1412 to the length of the projection of the connecting section 133 on the cell 120 is neither limited in the embodiments of this application, nor limited to the above examples.

It can be understood that the first area 1411 and the second area 1412 can be an integrally-molded structure, that is, the intermediate insulating portion 141 is an integrally-molded structure, which is convenient for the installation of the intermediate insulating portion 141 and can reduce the possibility of contact of the second section 132 and the part of the connecting section 133 close to the second section 132 of the connecting member 130 with the end of the cell 120.

As a possible implementation, referring to FIG. 1, FIG. 2 and FIG. 3, the insulating layer 140 includes a tab insulating portion 142, and the tab insulating portion 142 covers at least the first section 131 and a part of the connecting section 133.

Specifically, after the connecting member 130 is connected with the first tab 121, the side of the first tab 121 away from the cell 120 is covered by the tab insulating portion 142 to avoid a short circuit of the battery 100 since the first tab 121 approaches and comes into contact with the shell 110 during the installation process or the usage process of the battery 100, which makes it impossible to ensure normal use of the battery 100.

Furthermore, the tab insulating portion 142 can also cover a part of the connecting section 133 of the connecting member 130 close to the first section 131 to increase the coverage of the tab insulating portion 142, and increase the coverage of the insulating layer 140, and reduce the possibility of contact between the first tab 121 and the shell 110, and ensure the normal use of the battery 100.

As a possible embodiment, referring to FIG. 1, FIG. 2 and FIG. 3, the tab insulating portion 142 includes a third area 1421 and a fourth area 1422. The third area 1421 corresponds to a projection of the connecting section 133 on the first tab 121, and the fourth area 1422 corresponds to the first section 131. A ratio of a length of the third area 1421 to the length of the projection of the connecting section 133 on the cell 120 is 0%-50%.

Specifically, the fourth area 1422 may correspond to the first section 131 of the connecting member 130, the third area 1421 may be a projection of the connecting section 133 close to the first section 131 on the first tab 121, and the third area 1421 and the fourth area 1422 may be adjacent to each other.

It should be noted that the ratio of the length of the third area 1421 to the length of the projection of the connecting section 133 on the cell 120 may be greater than 0% and less than or equal to 50%. Preferably, the ratio of the length of the third area 1421 to the length of the projection of the connecting section 133 on the cell 120 may be greater than or equal to 20% and less than or equal to 50%. For example, the length ratio may be 20%, 25%, 30%, 35%, 40%, 45% or 50%. The specific ratio of the length of the third area 1421 to the length of the projection of the connecting section 133 on the cell 120 is neither limited in the embodiments of this application, nor limited to the above examples.

It can be understood that the third area 1421 and the fourth area 1422 may be an integrally-molded structure, that is, the tab insulating portion 142 is an integrally-molded structure, which facilitates the installation of the tab insulating portion 142 and reduces the possibility of contact between the first tab 121 and the shell 110.

Furthermore, the insulating layer 140 may simultaneously include the intermediate insulating portion 141 and the tab insulating portion 142. That is, the projection of the connecting section 133 of the connecting member 130 on the end of the cell 120 corresponds to the second area 1412 of the intermediate insulating portion 141, and the projection of the connecting section 133 of the connecting member 130 on the first tab 121 corresponds to the third area 1421 of the tab insulating portion 142.

It can be understood that the ratio of the length of the first area 1411 to the length of the projection of the connecting section 133 on the cell 120 is 0%-50%, and the ratio of the length of the third area 1421 to the length of the projection of the connecting section 133 on the cell 120 is 0%-50%. When both the ratio of the length of the first area 1411 to the length of the projection of the connecting section 133 on the cell 120 and the ratio of the length of the third area 1421 to the length of the projection of the connecting section 133 on the cell 120 is 50%, the projection of the connecting section 133 on the cell 120 corresponds to the intermediate insulating portion 141 and the tab insulating portion 142, which can well avoid the contact between the connecting section 133 and the end of the cell 120 and the contact between the first tab 121 and the shell 110.

As a possible embodiment, an angle between the connecting section 133 and the first section 131 or the second section 132 of the connecting member 130 is A, and in a direction in which the connecting member 130 approaches or moves away from the cell 120, the distance between the first section 131 and the second section 132 is B, and the sum of the length of the second area 1412 and the length of the third area 1421 is less than B/tan A.

It can be understood that a ratio of the distance B between the first section 131 and the second section 132 to the tangent function of the angle A between the connecting section 133 and the first section 131 or the second section 132 is a distance of the connecting section 133 of the connecting member 130 in a direction perpendicular to the direction B, which is a distance C between the first section 131 and the second section 132 in a direction perpendicular to the direction in which the connecting member 130 approaches or moves away from the cell 120. That is, the sum of the length of the second area 1412 and the length of the third area 1421 is less than the distance C between the first section 131 and the second section 132. That is, there is a gap between the second area 1412 and the third area 1421, that is, there is a gap between the intermediate insulating portion 141 and the tab insulating portion 142, which can ensure independent operation of the first tab 121 and the connecting member 130.

As a possible embodiment, referring to FIG. 1, FIG. 2 and FIG. 3, there are two connecting members 130, the two connecting members 130 are respectively connected with the first tab 121 and the second tab 122, an area between the first tab 121 and the second tab 122 is a middle area, and both the two connecting members 130 are located in the middle area. The projection of the insulating layer 140 on the end surface of the cell 120 covers at least a part of the projections of the two connecting members 130 on the end surface of the cell 120.

Specifically, the two first tabs 121 may have different polarities. For example, one first tab 121 is positive electrode, and the other first tab 121 is negative electrode. The polarity of the first tabs 121 connected with the two connecting members 130 is neither limited in the embodiments of this application, nor limited to the above example.

Furthermore, if the connecting member 130 has polarity, preferably, the connecting member 130 has the same polarity as the connected first tab 121.

It can be understood that, in order to facilitate the coverage of the insulating layer 140, the two first tabs 121 can be located on the same end of the cell 120. The area between the two first tabs 121 on the end of the cell 120 is the middle area, and both the two connecting members 130 are located in the middle area.

Furthermore, in order to reduce positioning steps for the intermediate insulating portion 141, the projection of the insulating layer 140 on the end surface of the cell 120 covers at least the projections of the two connecting members 130 on the end surface of the cell 120. That is, the intermediate insulating portion 141 of the insulating layer 140 can simultaneously cover the second sections 132 and the part of the connecting sections 133 close to the second sections 132 corresponding to the two connecting members 130, that is, the intermediate insulating portion 141 covers the second sections 132 and the part of the connecting sections 133 close to the second sections 132 corresponding to the two connecting members 130, and the area between the second sections 132 of the two connecting members 130.

As a possible embodiment, referring to FIG. 1, the intermediate insulating portion 141 is located between the end of the cell 120 and the connecting member 130, and the tab insulating portion 142 covers at least the connection area of the connecting member 130 with the first tab 121.

Furthermore, the tab insulating portion 142 may also cover the connection area of the connecting member 130 with the second tab 122, so that the insulating layer 140 can provide insulation between the connecting member 130 and the end of the cell 120, and meanwhile, provide insulation between the first tab 121, the second tab 122 and the shell 110.

As a possible embodiment, referring to FIG. 1, FIG. 2 and FIG. 3, the insulating layer 140 is insulating glue, by which the position of the connecting member 130 can be fixed relative to the cell 120 and the insulation between the connecting member 130 and the end of the cell 120 is simultaneously achieved, and by which the first tab 121 and the second tab 122 can also be fixed on the cell 120, so that the position of the first tab 121 and the second tab 122 is fixed relative to the cell 120, and the stability of the electric connection between the first tab 121 or the second tab 122 and the cell 120 is ensured.

In the battery 100 provided in the embodiments of this application, the shell 110 can provide protection to prevent the battery 100 from being affected by collision; the end of the cell 120 is provided with a first tab 121 and a second tab 122, and electric connection for the cell 120 is achieved through the first tab 121 and the second tab 122; a part of the connecting member 130 is connected with the first tab 121 for the electric connection with the first tab 121; the insulating layer 140 covers at least the connecting member 130 and the side of the first tab 121 away from the cell 120, which can prevent contact of the connecting member 130 electrically connected with the first tab 121 with the shell 110 to protect the connecting member 130 electrically connected with the first tab 121; the insulating layer 140 includes the intermediate insulating portion 141 and the tab insulating portion 142, and the intermediate insulating portion 141 can cover the orthographic projection of the second section 132 of the connecting member 130 on the end of the cell 120 and the part of the connecting section 133 of the connecting member 130 close to the second section 132, which can avoid short circuit of the battery 100 due to that the connecting member 130 is shifted and further approaches the end of the cell 120 and comes into contact with the end of the cell 120 during the installation process or the usage process of the battery 100, which makes it impossible to ensure normal use of the battery 100; the tab insulating portion 142 can cover the side of the first tab 121 away from the cell 120 and the part of the connecting section 133 of the connecting member 130 close to the first section 131, so as to avoid the short circuit of the battery due to that the first tab 121 approaches and comes into contact with the shell 110 during the installation process or the usage process of the battery 100, which makes it impossible to ensure the normal use of the battery 100; the ratio of the second area 1412 or the third area 1421 to the projection of the connecting section 133 on the cell 120 is 0%-50%, which can well avoid contact of the connecting section 133 with the end of the cell 120 and contact of the first tab 121 with the shell 110; there are two connecting members 130, and the two connecting members 130 correspond to the first tab 121 and the second tab 122, respectively.

FIG. 4 is a schematic diagram of a structure of an electronic device provided in an embodiment of this application.

In a second aspect, referring to FIG. 4, an embodiment of this application further provides an electronic device 200, including a device shell 210 and the battery 100, where the battery 100 is located in the device shell 210.

It can be understood that the electronic device 200 may be a portable electronic device 200 such as a mobile phone, a tablet computer, a laptop computer or a personal digital assistant, or it may be any device with the lithium battery 100 such as an electric vehicle power supply, a motor vehicle power supply, a power bank, etc. The specific form of the electronic device 200 is neither limited in the embodiments of this application, nor limited to the above examples.

The electronic device 200 provided in the embodiments of this application may have the battery 100 described in the above embodiments. By using the above battery 100, the electronic device 200 can avoid a short circuit of the battery 100 due to that the connecting member 130 of the battery 100 is shifted and approaches the end of the cell 120 of the battery 100 and comes into contact with the end of the cell 120 during the installation or usage process, which makes it impossible to ensure normal use of the battery 100, and meanwhile avoids a short circuit of the battery 100 since the first tab 121 of the battery 100 approaches and comes into contact with the shell 110 of the battery 100, which makes it impossible to ensure normal use of the battery 100, thereby ensuring normal use of the electronic device 200.

The orientations or positional relationships indicated by terms such as “above”, “below”, “front”, “back”, “vertical”, “horizontal”, “top”, “bottom”, “inside” and “outside” are based on the orientations or positional relationships shown in the accompanying drawings and are only for the convenience of describing this application and simplifying the description, rather than indicating or implying that the device or element referred must have a specific orientation, be constructed and operated in a specific orientation, and therefore should not be understood as a limitation on this application. In the description of this application, “plurality” means two or more than two, unless otherwise precisely and specifically specified.

The terms “first”, “second”, “third”, “fourth”, etc. in the specification and claims of this application and the above drawings are used to distinguish similar objects and are not necessarily used to describe a specific order or sequence. It should be understood that such data are interchangeable under appropriate circumstances such that the embodiment of the application described herein can be implemented in sequences other than those illustrated or described herein. In addition, the terms “include”, “have” and any variations thereof are intended to cover non-exclusive inclusions. For example, a process, method, system, product, or device that includes a series of steps or elements is not necessarily limited to those steps or units listed explicitly, but may include other steps or units not explicitly listed or inherent to such process, method, product, or device.

Finally, it should be noted that the above embodiments are only used to illustrate, rather than to limit, the technical solutions of this application. Although this application has been described in detail with reference to the afore-mentioned embodiment, those of ordinary skill in the art should understand that the technical solutions described in the afore-mentioned embodiments can be amended, or some or all of the technical features therein can be equivalently replaced. However, the essence of the corresponding technical solutions is not deviated from the scope of the technical solutions of the embodiments of this application by these amendments or replacements.

What is claimed is:

1. A battery, comprising a shell, a cell, a connecting member and an insulating layer, wherein the shell has a cavity, both the cell and the connecting member are located in the cavity, an end of the cell is provided with a first tab and a second tab, and a part of the connecting member is connected with the first tab;
the insulating layer is located between the first tab and the second tab, and a projection of the insulating layer on an end surface of the cell covers at least a part of a projection of the connecting member on the end surface of the cell.

2. The battery according to claim 1, wherein the insulating layer further covers at least the connecting member and a side of the first tab away from the cell.

3. The battery according to claim 2, wherein the connecting member comprises: a first section and a second section, extension directions of which are parallel to each other; and a connecting section connecting the first section and the second section; wherein an extension direction of the connecting section intersects with an extension direction of the first section;
the first section is connected with the first tab.

4. The battery according to claim 3, wherein the insulating layer comprises an intermediate insulating portion, and the intermediate insulating portion covers at least projections of the second section and a part of the connecting section on the cell;
and/or, the insulating layer comprises a tab insulating portion, and the tab insulating portion covers at least the first section and a part of the connecting section.

5. The battery according to claim 4, wherein the intermediate insulating portion comprises a first area and a second area, the first area corresponds to a projection of the second section on the cell, and the second area corresponds to a projection of the connecting section on the cell; the tab insulating portion comprises a third area and a fourth area, the third area corresponds to a projection of the connecting section on the tab, and the fourth area corresponds to the first section;
a ratio of a length of the second area to a length of the projection of the connecting section on the cell is 0%-50%; a ratio of a length of the third area to the length of the projection of the connecting section on the cell is 0%-50%.

6. The battery according to claim 5, wherein an angle between the connecting section and the first section or the second section of the connecting member is A, and a distance between the first section and the second section in a direction in which the connecting member approaches or moves away from the cell is B;
a sum of the length of the second area and the length of the third area is less than B/tan A.

7. The battery according to claim 1, wherein an amount of the connecting member is 2, the two connecting members are respectively connected with the first tab and the second tab, an area between the first tab and the second tab is a middle area, and both the two connecting members are located in the middle area;
the projection of the insulating layer on the end surface of the cell covers at least a part of projections of the two connecting members on the end surface of the cell.

8. The battery according to claim 4, wherein the intermediate insulating portion is located between the end of the cell and the connecting member, and the tab insulating portion covers at least a connection area of the connecting member with the first tab.

9. The battery according to claim 1, wherein the insulating layer is insulating glue.

10. The battery according to claim 2, wherein the insulating layer is insulating glue.

11. The battery according to claim 3, wherein the insulating layer is insulating glue.

12. The battery according to claim 4, wherein the insulating layer is insulating glue.

13. The battery according to claim 5, wherein the insulating layer is insulating glue.

14. The battery according to claim 6, wherein the insulating layer is insulating glue.

15. The battery according to claim 7, wherein the insulating layer is insulating glue.

16. The battery according to claim 8, wherein the insulating layer is insulating glue.

17. An electronic device, comprising a device shell and the battery according to claim 1, wherein the battery is located in the device shell.
